(19) United States
(12) Patent Application Publication
(10) Pub. No.: US 2006/0280667 A1
(43) Pub. Date: Dec. 14, 2006

(54) Purification of off-gases from gas-fired plants

(76) Inventors: John Oonkj, Apeldoom (NL); Franciscus Petrus Thomas Willems, Breda (NL); Yves Lodewijk Maria Creijgton, Delft (NL)

Correspondence Address: Ronald J Baron;Hoffmann & Baron, 6900 Jericho Turnpike, Syossett, NY, 11971, US

(21) Appl. No.: 10/552,311

(22) PCT Filed: Mar. 29, 2004
(86) PCT No.: PCT/NL04/00213

§ 371 Date: Oct. 7, 2005

(30) Foreign Application Priority Data
Mar. 28, 2003 (NL) 1023045

(51) Int. Cl. B01D 53/86

(52) U.S. Cl. 423/239.1

(57) ABSTRACT

The invention relates to a method and apparatus for purifying off-gasses of gas-fired plants. According to the invention, just methane or both metane and Nox contents in an off-gas stream of a plant are reduced by contacting the off-gas stream with a plasma and a catalyst.

The invention relates to a method and apparatus for purifying off-gases from gas-fired plants and specifically gas engines.

Gas engines are used inter alia for combined heat and power (CHP) generation and for this reason are used to an increasing extent because in this way energy savings, and hence a reduction of CO₂ emissions, can be accomplished. However, a drawback is that small-scale energy generation with CHP gas engines leads to increased emissions of NOx and methane compared with large-scale electricity generation in power stations.

In recent research, the methane problems have been mapped and the methane slip is estimated to be 1.8% of the primary fuel deployment (see: Gastec, 2001: Kwaliteit gasmotoren in Nederland [Gas engine quality in the Netherlands], Gastec report GL/010476, Gastec, Apeldoorn). Methane is a greenhouse gas which, on a weight basis, is 21 times stronger than CO₂ (100 years of integration time, including indirect effects). However, methane slip not only means a contribution to the greenhouse effect, so that the favorable effect of CHP on CO₂ emissions is partly undone again; methane slip also means a reduction of the efficiency of the plant. For all sources of non-CO₂ greenhouse gases, it is currently being investigated what the possibilities are for emission reduction.

The NOx emission of a gas engine is considerably higher than that of large-scale energy generation. As a result of increased CHP in the Netherlands, the reduction of acidifying emissions in the Netherlands has slowed down. According to the expectations of the Energy Research Center of the Netherlands (ECN), the CHP engine fleet will grow in the next 10 years, and with unchanged regulations NOx emissions will increase proportionally. For Europe a similar growth is expected (see: ECN, 2000: “Mogelijke effecten van NOx-beleid op het warmte-krachtpotentieel” [Possible effects of NOx policy on the heat-power potential”], ECN report ECN-C-00-111).

Controlling simultaneous NOx and methane emissions by taking engine measures as a rule presents problems in gas engines, since there is a trade-off between methane and NOx emissions and also between energy consumption (CO₂ emission) and NOx emission: engine settings that are favorable in respect of NOx are often unfavorable in respect of methane emission and the energy consumption.

There are a number of possibilities for emission reduction of the individual components, NOx and methane. For NOx emission reduction, engine measures can be taken, but the reduction potential of NOx is limited to about 50% and these measures often result in an increase of the methane emission and a rise of the energy consumption. Another measure for NOx emission reduction is selective catalytic reduction (SCR) of NOx using ammonia or urea. However, on the scale of a gas engine, this is a relatively expensive measure, which moreover requires additional deployment of energy-rich co-reagents. For methane emission reduction there is no proven technology yet, not least because emission requirements for methane are currently still lacking. However, there are a number of possibilities. Engine measures can reduce emissions, but often result in an increase of the NOx emission. Further, methane in the waste gases may be catalytically oxidized, though with limited conversion efficiencies.

Methane-deNOx is proposed as a measure for emission reduction of both components in the case of lean-burn gas engines; however, the measure is not yet available on a realistic or pilot scale, while on a lab scale, efficiencies of NOx emission reduction remain limited under the more realistic conditions to 50% at a maximum (see for instance: Tena E. et al., “Cogeneration and SCR of NOx by natural gas: advances towards commercialisation”, NOXCONF 2001, Paris). According to the literature, SCR of NOx with methane does not proceed, or proceeds very slowly, so that very high contact times (corresponding to very low gas velocities, for instance expressed in gas hourly space velocity, GHSV) are needed to come to an acceptable NOx conversion. According to the literature, such low GHSV values render practical application impossible. Moreover, the catalytic conversion of NOx with CH₄ does not proceed selectively. This limitation in selectivity is caused by the chemical stability of methane, which only becomes reactive at elevated temperature. At this elevated temperature, the catalytic reaction of CH₄ with NOx is not selective anymore with respect to the non-catalytic reaction with combustion air. Another technology for DeNox is the selective catalytic reduction of NOx with hydrocarbons, in particular higher hydrocarbons. It proceeds especially efficiently and selectively when olefins (such as propene) are used as reductant. In the use of aliphatics (propane, butane), the reaction proceeds less successfully.

A possibility for simultaneous emission reduction of NOx, and CH₄ involves the switch to stoichiometric combustion in a gas engine. Given such a stoichiometric combustion, a three-way catalyst can be used for the simultaneous removal of NOx, CO and higher hydrocarbons. A stoichiometric combustion entails a few drawbacks where the heavier-duty engines or engines with a high specific load are concerned, such as a lowered energetic efficiency and an increased thermal loading.

In virtually every petrol-powered passenger car driving around at the moment, a stoichiometric combustion with three-way catalyst is used successfully. However, because methane in the exhaust gases of a gas engine is much less reactive than the higher hydrocarbons from an engine running, for instance, on petrol, the efficiency of a three-way catalyst in the emission reduction of specifically CH₄ remains limited when CNG is used as fuel.

U.S. Pat. No. 6,357,223 B1 discloses a method for converting compounds that can poison catalysts in off-gas streams. To this end, these compounds are reacted with particular active compounds, which are formed from water vapor or other gases, utilizing e.g. UV light or corona discharge. In this method, inter alia NO₂ may be formed, which is not desired.

The object of the present invention is to provide a solution to at least a part of the above-mentioned problems and is specifically directed to purification of off-gases from gas-fired plants. The crux of the problem is that methane, compared with other hydrocarbons, is insufficiently reactive. By making use of a plasma, methane is converted into more reactive components, which are better able to perform the desired catalytic reactions. It has been found that off-gas streams of gas-fired plants can be very suitably treated in a step in which so-called plasma assisted catalytic methane conversion is carried out. According to the invention, the methane can be converted with the aid of oxygen (for instance coming from the air; “plasmia-assisted oxy-cat”), so that a decrease in the methane content is obtained. Also, the methane can be converted with NOx present in the off-gas (“plasma assisted methane-DeNOx”), whereby a reduction of both. NOx and methane can be achieved in that NOx is reduced by the methane present. Accordingly, the invention concerns a method for reducing methane contents, and possibly NOx contents, in, an off-gas stream of a gas engine, wherein the off-gas stream is contacted with a plasma and a catalyst. According to the invention, the whole off-gas stream, or at least a substantial part thereof, is subjected to in situ plasma treatment, in contrast to the method of U.S. Pat. No. 6,357,223 B1, where only a fraction of the off-gas stream is passed through a corona discharge reactor, a so-called remote corona application.

Moreover, according to the invention, each part of the off-gas is contacted with radicals which are generated, spatially well distributed, in the plasma reactor. Because of short radical recombination times (order of magnitude is typically 1 to 100 microseconds); the radicals produced in a remote corona discharge will be less effective for the intended chemical conversion of NOx.

Thus, an emission reduction of CH₄ and if desired NOx is obtained, moreover with possibilities of increasing the total efficiency (sum of energetic and thermal efficiency) of the gas-fired plant. According to the invention, it is for instance possible, in a gas engine, to raise the compression ratio, to advance ignition, or to set the air/fuel ratio such that a lower fuel consumption is realized and the energy demand of the plasma is compensated. This setting yields a lower hydrocarbon emission and the increase of the NOx is undone by the plasma assisted catalytic reduction of NOx.

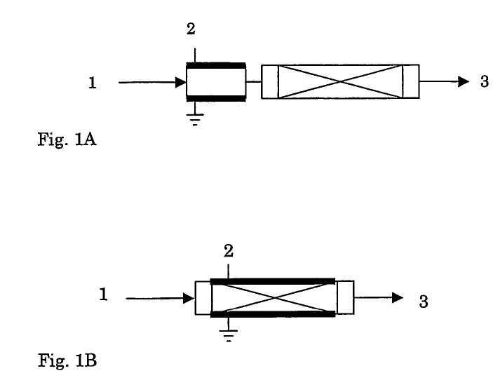

FIG. 1 schematically shows two embodiments according to the invention. In the embodiment according to FIG. 1A, the off-gas of a gas engine is first passed through a plasma reactor and subsequently through the catalyst bed. In the embodiment schematically represented in FIG. 1B, the plasma reactor and the catalyst bed are integrated.

The invention is specifically effective because the exhaust gas in most cases contains sufficient methane to reduce Nox completely. Should this not be the case, the methane content in the exhaust gas can be increased relatively simply through a different setting of the plant.

Although it cannot be stated with certainty what the most active components are that play a role in the chemistry of the present invention, it is assumed—without wishing to be bound to any theory—that according to the invention the following reactions occur.

In the plasma, there are free electrons with a characteristic electron energy in the range of 1-10 eV. The free electrons generate a large variety of chemically reactive particles in the exhaust gas, such as radicals (OH) and ions (CH₃^{_{−}}). CH₄ is converted both in a direct manner by electrons and in an indirect manner by radicals and ions. An occurring direct reaction is dissociative coupling of electrons with CH₄:
CH₄+e⁻→CH₃+H (1)
CH₄+O₂+e⁻→HO₂+CHₓO_{y} (2)

In addition, in the plasma reactor, nitrogen monoxide (NO) is converted according to:
NO+HO₂→NO₂+OH (3)
The reduction takes place on the catalyst:
NO₂+CHₓO_{y}→N₂+CO₂+H₂O (4)

Although a plasma reactor is capable of activating gas molecules, the reduction of NOx to N₂ cannot be effectively accomplished with it. Similarly, known catalysts for catalytic conversion of NOx with the aid of hydrocarbons under realistic conditions are not suitable for the conversion of methane and NOx to water, CO₂ and nitrogen. Surprisingly, with the combination according to the invention, it has been found that an effective reduction of NOx with methane can be achieved.

For catalytic conversion of NOx with methane, it is important that direct conversion of methane to CO₂ proceeds in a controlled manner, because CO₂ is not reactive anymore in the catalytic conversion of NOx; however, complete conversion of CH₄, either in reaction with NOx or in reaction with O₂ from combustion air remains desired. According to the invention, the controlled conversion of CH₄ is accomplished by use of the plasma. Again without wishing to be bound to any theory, it is assumed that the first oxidation step of CH₄ in the presence of plasma is no longer velocity-determinative (whereas this step is velocity-determinative in “conventional” oxidation of CH₄, that is, oxidation—combustion—without use of a plasma, because this first oxidation of CH₄ then has the highest activation energy). Through use of the plasma, the forming reactions of all oxidation products from methane (CH₃OH, CH₂O, CO, H₂) have a more or less equal, low, activation energy and these components will be formed in a more selective manner.

According to the invention, the plasma is generated by ionization of the components in the gases by means of a high electrical or electromagnetic field (for instance generated by microwaves). A suitable plasma reactor provides discharges at relatively high electrical fields (as a rule ca. 1-100 kV/cm, typically 10 kV/cm). As a result, free electrons, reactive radicals, ions and partially oxygenated compounds (CHₓO_{y}) are formed in the gaseous phase. The relatively high electrical fields are necessary because the pressure is also relatively high, viz. approximately atmospheric (this is high compared with customary plasma applications). Preferably, an AC voltage is used, which preferably has a frequency of 10 Hz to 100 kHz, typically ca. 1 kHz. Preferably, the electrical field is generated between a pair of electrodes, at least one of the electrodes being fully insulated from the off-gas by an electrically insulating layer consisting of, for instance, glass or ceramic. Because of the homogeneous spatial distribution of plasma filaments, which enable an effective in, situ treatment of the complete gas stream, the power density (W/cm³) of the plasma can remain limited. The power density of the plasma is determined to a large extent by the frequency of the plasma. This frequency is preferably below 1 kHz.

Preferably, the plasma is maintained with the aid of a partial discharge. Preferably, the partial discharge is generated by the use of a dielectric, such as ceramic or glass, which, preferably completely, covers one or more of the electrodes in the plasma reactor. In this way, a more compact apparatus can be obtained.

The temperature for performing the plasma reactions and the catalytic reactions are preferably set at 300-500° C., but this may vary for different applications. For use in the automobile industry, a temperature of approximately 350° C. is optimal. For combined heat and power systems, this temperature may be higher, for instance 360-370° C.

As catalyst, in principle all known three-way catalysts, hydrocarbon-NOx-SCR catalysts or oxidation catalysts are suitable, in particular catalysts based on zeolites (which may or may not be ion exchanged) or metal oxides such as γ-alumina, if desired activated with metals as silver, indium, platinum, palladium, copper or rhodium. In the choice of a suitable catalyst system, the following considerations can play a role. Suitable catalysts for use in CH₄-deNOx or methane oxidation must meet a number of requirements in respect of activity, stability and selectivity.

The catalysts should be active in a relatively wide temperature range of preferably about 200° C. to about 400° C. It is requisite that sufficient conversion be obtained at high GHSV, typically greater than 50 000 h⁻¹, running up to approximately 150 000 h⁻¹ or more. The catalyst systems should be able to adsorb and activate the reactants. Relevant in that respect are inter alia a sufficiently high pore volume, a sufficiently high specific surface area, a sufficient extent of dispersion of the catalytically active sites and a suitable acidity.

Suitable catalyst systems contribute to the following desired reactions 1) to 5).

| | |
|---|---|
| Oxidation | 1) NO + O₂ → NO₂ |
| | 2) CₓH_{y} + O₂ → CₓH_{y}O_{z} of CO |
| H2 generation | 3) CₓH_{y} + H₂O → H₂ + CO + CO₂ |
| NOx reduction | 4) NO/NO₂ + CₓH_{y}/CₓH_{y}O_{z}/CO → N₂ + CO₂ + H₂O |
| Hydrocarbon | 5) CH₂, CₓH_{y}O_{z} → CO₂ and H₂O |
| oxidation: | |

The following undesired reactions 6) to 11) should be prevented as much as possible:

| | |
|---|---|
| NOx conversion | 6) NO₂ → NO + O₂ |
| | 7) NO → N₂O |
| Oxidation | 8) NO₂ + CₓH_{y} → CO, CO₂ + NO |
| | 9) SO₂ → SO₃(→ H₂SO₄ With H₂O) |
| | 10) CₓH_{y} → CO₂ |
| Deposition | 11) CₓH_{y} → C |

As regards the selectivity, the catalyst system used should preferably promote the oxidation of hydrocarbons, without this leading to non-selective combustion. In other words, preferably, eventually reaction 4) is maximized, while reactions 6) to 11) are minimized. The catalyst system should also be stable to a sufficient extent at the temperature used, especially in the presence of components such as H₂O, SO₂, coke, Cl, As, P, Si. Also, the catalyst system used should offer sufficient resistance to mechanical erosion.

Very suitable catalyst systems that can meet the above-mentioned requirements are catalysts based on γ-Al₂O₃. γ-Al₂O₃ is active in CH₄-SCR, although according to the prior art this holds specifically at high temperatures. According to the invention, however, NOx is for a considerable part present in the form of NO₂, which proves to be considerably more reactive than NO. γ-Al₂O₃ moreover offers a good sulfur and water tolerance and can easily be modified with different metals and additives.

Very suitable as catalyst,support for CH₄-deNOx under lean-burn conditions are inter alia different types of Al₂O₃, zeolites, in particular H-Zeolites (H-USY, H-FER, H-ZSM5, H-MOR), oxides such as ZrO₂, Ga₂O₃, perovskite and combinations (mixtures or layered structures) thereof Perovskite is suitable in particular because it enables the simultaneous removal of NOx and soot particles. As active phases on these supports, metals, metal ions and metal oxides can be used. Very suitable are silver and platinum. Silver is specifically suited for reducing NO₂. Platinum is suitable in particular because of the high activity at low temperatures. Other suitable metals are In, Ce, Au, Fe, Pd and Sn, because these are capable of reducing NO₂ very effectively. Finally, BaO-based systems are mentioned. This so-called storage reduction catalyst can bind NOx in the form of nitrates and in this way enhance the activity of the catalyst system.

A suitable catalyst system for plasma-assisted deNox in lean burn gas engines comprises, for instance, Ag/Al₂O₃ or Ag/H-Zeolite. Such a system gives a high conversion, possesses a good stability and is especially active for the conversion of NOx with partially oxidized hydrocarbons (for instance MeOH). Other examples include In/Zeolite In₂O₃/Ga₂O₃, Pt/Al₂O₃, etc.

A suitable catalyst system for plasma-assisted methane oxidation in lean-burn gas engines comprises, for instance, Ag or Pt on Al₂O₃ or H-Zeolite support. However, also other catalysts that are proposed by others as oxidation catalyst for hydrocarbons can be suitable.

For plasma-assisted deNOx in stoichiometric engines, specifically all three-way catalysts are suitable, such as they have currently been developed by third parties, and are mostly based on rhodium, platinum or platinum on an alumina support, with sometimes additions of cerium, lanthanum, zirconium or cerium.

In the embodiment schematically represented in FIG. 1A, the off-gas (1) to be cleaned is first passed through a plasma reactor, which is connected at (2) with a voltage source. Next, the gas stream passes the catalyst bed. The cleaned gas is obtained at (3).

The reference numerals in FIG. 1B have corresponding meanings to FIG. 1A. In this embodiment, plasma reactor and catalyst bed are integrated. This provides two advantages over the sequential embodiment of FIG. 1A: in the first place, a more compact plant is obtained. In the second place, any reverse reactions (for instance of the activated NO₂ to NO) are prevented because the more active components can react away directly over the catalyst.

1. A method for reducing the methane content in an off-gas stream of a gas-fired plant, wherein at least a portion of said off-gas stream is contacted with a plasma and a catalyst.

2. A method according to claim 1, wherein further the NOx content of said off-gas stream is reduced.

3. A method according to claim 1, wherein said plasma is generated by the use of an electrical or an electromagnetic field.

4. A method according to claim 3, wherein the plasma is generated by use of an electrical field of 1-100 kV/cm.

5. A method according to claim 1, wherein the plasma is generated by means of an alternating voltage of a frequency of 100 Hz to 100 kHz.

6. A method according to claim 1, wherein the plasma is maintained with the aid of a partial discharge.

7. A method according to claim 6, wherein the partial discharge is generated by use of a dielectric.

8. A method according to claim 1, wherein the whole off-gas stream or virtually the whole off-gas stream is contacted with said plasma and said catalyst.

9. A method according to claim 1, which is carried out at a temperature of 300-500° C.

10. A method according to claim 1, wherein said catalyst comprises Al₂O₃, zeolite, ZrO₂, Ga₂O₃, TiO₂, WO₃, perovskite or combinations thereof.

11. A method according to claim 8, wherein said catalyst comprises γ-Al₂O₃.

12. A method according to claim 1, wherein said catalyst is a three-way catalyst, which comprises Rh, Pt or Pd on Al₂O₃ support, if desired with additions of Ce, La, Zr or Ce.

13. A method according to claim 1, wherein said catalyst is an oxidation catalyst, which comprises Ag or Pt on a metal oxide support.
